(19) United States
(12) Patent Application Publication
(10) Pub. No.: US 2017/0026545 A1
(43) Pub. Date: Jan. 26, 2017

(54) DEVICE LINKAGE SYSTEM, METHOD FOR CONTROLLING DEVICE LINKAGE SYSTEM, AND RECORDING MEDIUM

(71) Applicants: Takuya MORI, Tokyo (JP); Atsushi OKAZATO, Kanagawa (JP); Junki AOKI, Kanagawa (JP)

(72) Inventors: Takuya MORI, Tokyo (JP); Atsushi OKAZATO, Kanagawa (JP); Junki AOKI, Kanagawa (JP)

(73) Assignee: Ricoh Company, Ltd., Tokyo (JP)

(21) Appl. No.: 15/210,975

(22) Filed: Jul. 15, 2016

(30) Foreign Application Priority Data
Jul. 23, 2015 (JP) 2015-146207

(51) Int. Cl. H04N 1/34; G06F 17/30; G06Q 30/04; H04N 1/32; H04N 1/00

(52) U.S. Cl. CPC H04N 1/344; H04N 1/32101; H04N 1/00307; G06Q 30/04; G06F 17/30368; H04N 2201/0094; H04N 2201/3205; H04N 2201/0039

(57) ABSTRACT

A device linkage system includes: a device-information storage part configured to store device linkage information containing device identification information of devices to be linked and information about functions to be performed by the devices; a linkage function controller configured to Perform control to cause at least one device of the devices to perform at least one function of the functions in accordance with the device linkage information if it is determined that the at least one function is permitted to be performed by the at least one device based on billing-related information containing billing information representing a function-use right and information about unit costs for use of the functions; and a billing-information update part configured to update the billing information in accordance with the billing-related information and the at least one function that the linkage function controller has caused the at least one device to perform.

### CROSS-REFERENCE TO RELATED APPLICATIONS

The present application claims priority under 35 U.S.C. 119 to Japanese Patent Application No. 2015-146207, filed Jul. 23, 2015. The contents of which are incorporated herein by reference in their entirety.

### BACKGROUND OF THE INVENTION

1. Field of the Invention

The present invention relates to a device linkage system, a method for controlling the device linkage system, and a recording medium.

2. Description of the Related Art

Conventionally, a system (hereinafter, referred to as “device linkage system”) that causes a plurality of devices (including an image forming apparatus, for example) to operate in a linked manner, thereby implementing a function that cannot be provided by a single device or causing a function provided by a device, to be performed from another device is known. In a conventional technology, such a device linkage system manages billing for use of functions individually for each device.

Japanese Unexamined Patent Application Publication No. 2002-199118 (Patent Document 1) discloses a system that includes a billing management server and performs centralized management of billing for use of functions, thereby eliminating the need for each device to have billing capability.

When it is required that each device in a device linkage system should have billing capability as in the conventional technology, inexpensive devices, such as printers, that do not have billing capability cannot be included in such a device linkage system, which makes it difficult to reduce the introducing cost. Although the system disclosed in Patent Document 1 eliminate the need for each device to have billing capability, it is difficult to reduce cost for introducing and operating the system because the system requires constructing and operating the system including the billing management server.

### SUMMARY OF THE INVENTION

According to one aspect of the present invention, a device linkage system includes a device-information storage part, a billing-information input part, a billing-information storage part, a performing-function-permission determination part, a linkage function controller, and a billing-information update part. The device-information storage part is configured to store device linkage information containing device identification information of devices to be linked and information about functions to be performed by the devices. A billing-information input part is configured to accept billing information representing a function-use right. A billing-information storage part is configured to store billing-related information containing the billing information entered to the billing-information input part and information about unit costs for use of the functions. A performing-function-permission determination part is configured to determine whether or not the functions are permitted to be performed by the devices based on the billing-related information stored in the billing-information storage part. A linkage function controller is configured to perform control to cause at least one device of the devices to perform at least one function of the functions in accordance with the device linkage information stored in the device-information storage part if the performing-function-permission determination part determines that the at least one function is permitted to be performed by the at least one device. A billing-information update part is configured to update the billing information stored in the billing-information storage part in accordance with the billing-related information stored in the billing-information storage part and the at least one function that the linkage function controller has caused the at least one device to perform.

### BRIEF DESCRIPTION OF THE DRAWINGS

FIG. 1 is a schematic diagram illustrating an example system configuration of a device linkage system of a first embodiment;

FIG. 2 is a block diagram illustrating an example of a hardware configuration of a multifunction peripheral as a device of the first embodiment;

FIG. 3 is a block diagram illustrating an example of a hardware configuration of a mobile terminal of the first embodiment;

FIG. 4 is a block diagram illustrating an example of a functional configuration of the device linkage system of the first embodiment implemented with a discrete scanner and a discrete printer as devices, and the mobile terminal;

FIG. 5 is a sequence diagram illustrating a flow of processing between apparatuses when linking a scanning function of the discrete scanner as the device, and a printing function of the discrete printer as the device, to perform a linkage function (in this example, “copying”) in the device linkage system of the first embodiment;

FIG. 6 is a sequence diagram illustrating a flow of processing (first example of entering billing information) between the mobile terminal and a web server when a user operates the mobile terminal to purchase a function-use right (amount of money) from the web server;

FIG. 7 is a sequence diagram illustrating a procedure and a flow of processing (second example of entering billing information) between a user, the mobile terminal, and the web server when the user purchases a function-use right at a store in the first embodiment;

FIG. 8 is a flowchart describing how the mobile terminal operates in the first embodiment when causing a linkage function to be performed;

FIG. 9 is a flowchart describing how the mobile terminal operates in a second embodiment when causing a linkage function to be performed;

FIG. 10 is a block diagram illustrating an example of a functional configuration of a device linkage system of a third embodiment implemented with the discrete scanner and the discrete printer, which are the devices, and the mobile terminal;

FIG. 11 is a flowchart describing how the mobile terminal operates in the third embodiment when causing a linkage function to be performed;

FIG. 12 is a block diagram illustrating an example of a functional configuration of a device linkage system of a fourth embodiment implemented with the discrete scanner and the discrete printer, which are the devices, and the mobile terminal;

FIG. 13 is a flowchart describing how the mobile terminal operates in the fourth embodiment when causing a linkage function to be performed;

FIG. 14 is a block diagram illustrating an example of hardware configuration of the web server of a fifth embodiment;

FIG. 15 is a block diagram illustrating an example of a functional configuration of a device linkage system of the fifth embodiment implemented with the discrete scanner and the discrete printer, which are the devices, the mobile terminal, and the web server;

FIG. 16 is a sequence diagram. illustrating a procedure and a flow of processing (for making determination about billing information) between a user, the mobile terminal, and the web server when the user purchases a function-use right at the store in the fifth embodiment;

FIG. 17 is a sequence diagram illustrating a flow of processing when billing information is transferred to another mobile terminal in a sixth embodiment; and

FIG. 18 is a flowchart describing how the mobile terminal operates in a seventh embodiment when causing a linkage function to be performed.

The accompanying drawings are intended to depict exemplary embodiments of the present invention and should not be interpreted. to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and the are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of the present invention are described in detail below with reference to the accompanying drawings. Description about configurations, elements, and portions that are common between the embodiments described below is omitted as appropriate.

### First Embodiment

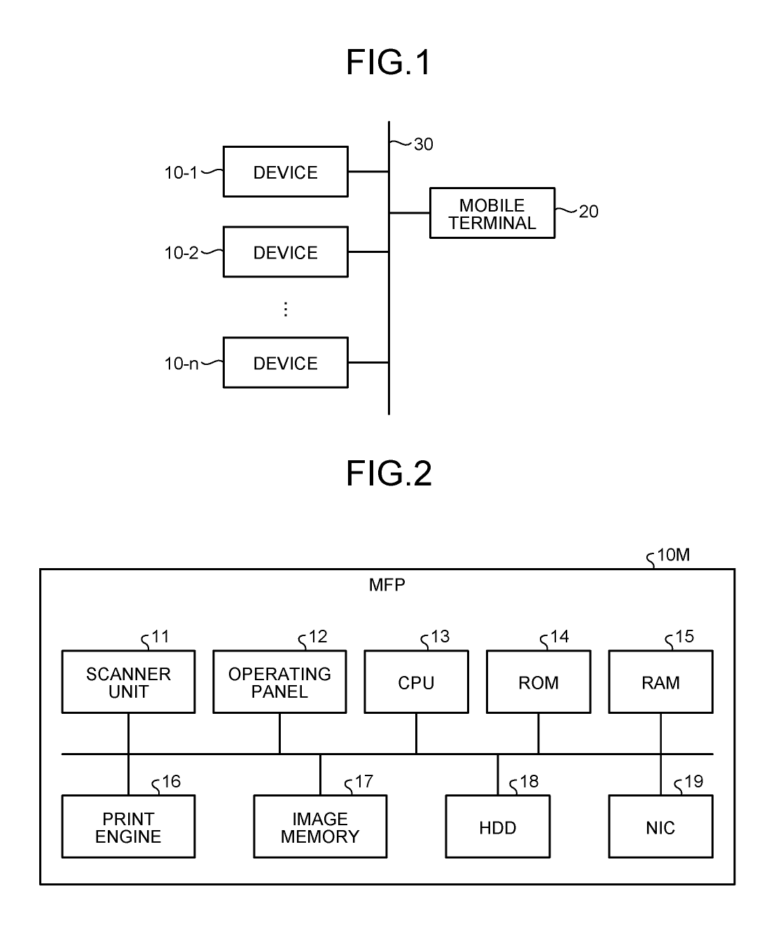

FIG. 1 is a schematic diagram illustrating an example system configuration of a device linkage system of a first embodiment.

As illustrated in FIG. 1, the device linkage system of the present embodiment includes devices 10-1, 10-2, . . . , and 10-n being billing targets, and a mobile terminal 20. The devices 10-1, 10-2, . . . , and 10-n and the mobile terminal 20 are connected via a network 30 with wire or wirelessly. Examples of the network 30 include a LAN (Local Area Network) and the Internet. Hereinafter, when it is unnecessary to individually distinguish the devices 10-1, 10-2, . . . , and 10-n, each of the devices 10-1, 10-2, . . . , and 10-n is simply referred to as “the device 10”. Although FIG. 1 illustrates an example where the number of the mobile terminal 20 is one, the number of the mobile terminal 20 is not limited thereto, and can be any number.

It is assumed that the device 10 is an image forming apparatus, such as a printer, a copier, an MFP (Multifunction Peripheral), a scanner apparatus, and a facsimile apparatus. However, the device 10 is not limited thereto, and may be a device, such as a projector, other than an image forming apparatus. The description below is given through an example where the device 10 is a general MFP, which is denoted as an MFP 10M. The mobile terminal 20 can be implemented as a dedicated mobile device; alternatively, the mobile terminal 20 can be implemented by installing a dedicated software application on a mobile terminal, such as a general smartphone.

FIG. 2 is a block diagram illustrating an example of a hardware configuration of the MFP 10M, which is the device 10 in the present embodiment.

As illustrated in FIG. 2, the NFP 10M includes a scanner unit 11, an operating panel 12, a CPU 13, a ROM 14, a RAM 15, a print engine 16, an image memory 17, an HDD 18, and an NIC 19. Note that the hardware configuration of the MFP 10M presented in FTG. 2 is merely illustrative and not limiting.

The scanner unit 11 is an optical apparatus that scans an original document placed on a document table to generate image data.

The operating panel 12 is either an apparatus integrated with a main body of the NFP 10M or a terminal removable from the NFP 10M, and includes a GUI for use by a user in performing operations. The operating panel 12 includes an LCD (Liquid Crystal Display) for displaying a screen, an LED (Light Emitting Diode) for indicating a state, a buzzer, a hard key, and a touch panel, displays a variety of information on the LCD, and accepts a variety of information from the hard key and the touch panel.

The CPU 13 is a processor that performs overall control of the MFP 10M. The CPU 13 also performs a variety of image processing on read image data obtained by the scanner unit 11 or image data to be printed and output by the engine 16. The ROM 14 stores a program to be executed by the CPU 13 and/or the like. The RAM 15 is a main storage of the CPU 13 and also used as a work area of the CPU 13. The CPU 13 loads a control program stored in the ROM 14 into the PAM 15 and executes the control program to perform overall control of the MFP 10M.

The print engine 16 is an apparatus that prints image data processed in the MFP 10M on recording media The image memory 17 is a memory that stores the read image obtained by the scanner unit 11 and the image data to be printed and output by the print engine 16. The HDD 18 stores setting data, a variety of data, and a program for use by the CPU 13.

The NIC is a communication interface for connecting the MFP 10M to the network 30.

Each of a discrete printer, a copier, a discrete scanner apparatus, and a discrete facsimile apparatus, each used as the device 10, can be considered as being configured by removing functions and apparatuses unnecessary for the printer, the copier, scanner apparatus, or the facsimile apparatus from the functions and apparatuses included in the MFP 10M.

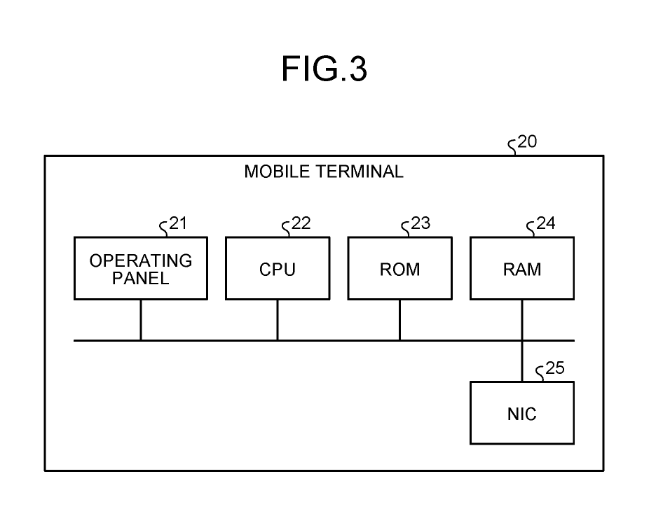

FIG. 3 is a block diagram illustrating an example of a hardware configuration of the mobile terminal 20 of the present embodiment.

As illustrated in FIG. 3, the mobile terminal 20 includes an operating panel 21, a CPU 22, a ROM 23, a RAM 24, and an NIC 25. Note that the hardware configuration of the mobile terminal 20 presented in FIG. 3 is merely illustrative and not limiting.

The operating panel 21 is an apparatus including a GUI for use by a user in performing various operations on the mobile terminal 20 and includes an LCD and an input device, such as a hard key and a touch panel. The operating panel 21 displays a variety of information on the LCD and accepts a variety of information from the hard key and the touch panel.

The CPU 22 is a processor that performs overall control of the mobile terminal 20. The ROM 23 stores a program to be executed by the CPU 22, a variety of setting data, and the like. The ROM 23 may include a rewritable ROM, such as an EEPROM (Electrically Erasable Programmable Read-Only Memory). The RAM 24 is a main storage of the CPU 22 and also used as a work area of the CPU 22. The CPU 22 loads a control program stored in the ROM 23 into the RAM 24 and executes the control program to perform overall control of the mobile terminal.

The NIC 25 is a communication interface for connecting the mobile terminal 20 to the network 30 such that the mobile terminal 20 can be connected to an external web server and/or the like.

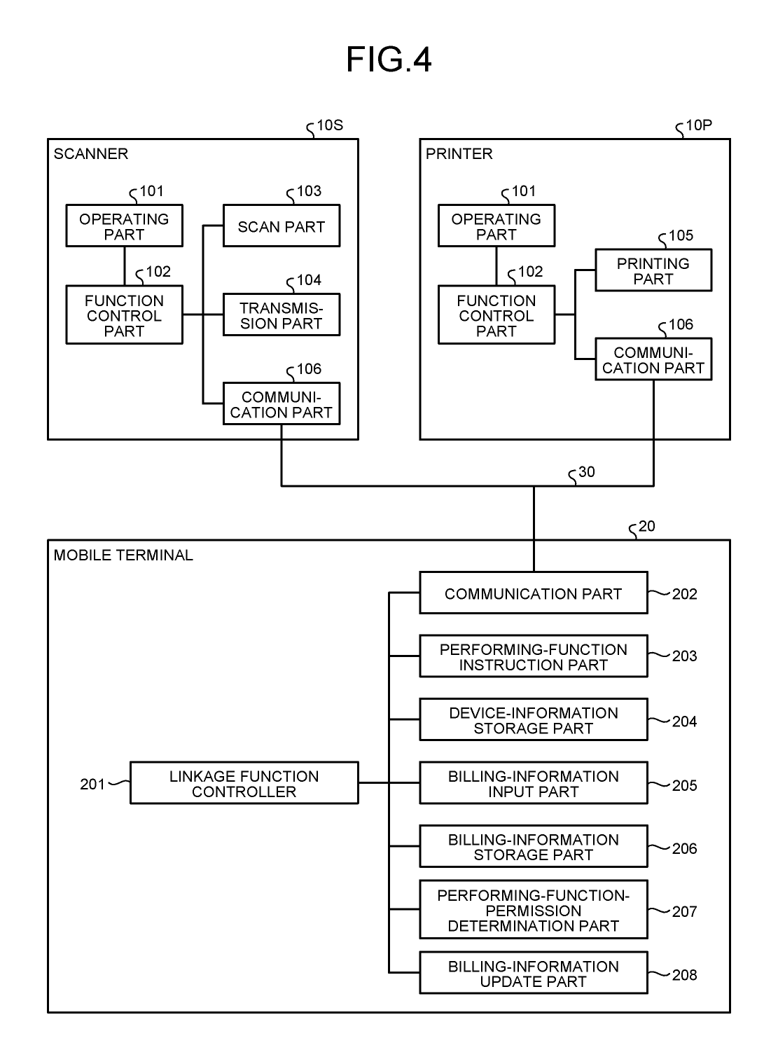

FIG. 4 is a block diagram illustrating an example of a functional configuration of the device linkage system of the present embodiment implemented with a discrete scanner 10S and a discrete printer 10P as the devices 10, and the mobile terminal 20. Parts of the apparatuses illustrated in FIG. 4 are described below.

Scanner and Printer

An operating part 101 accepts an instruction that a user directly operates the operating part 101 to enter or enters indirectly via another apparatus, to perform a function(s), various setting inputs, and/or the like. The operating part 101 is implemented by the operating panel 12 described above with reference to the hardware configuration diagram of FIG. 2.

A function control part 102 performs control necessary to perform the function(s) specified in accordance with the user's instruction accepted by the operating part 101. The function control part 102 is implemented by the CPU 13 and the RAM 15 described above with reference to the hardware configuration diagram of FIG. 2.

A scan part 103 scans an original document to generate image data. The scan part 103 is implemented by the scanner unit 11 and the image memory 17 described above with reference to the hardware configuration diagram of FIG. 2.

A transmission part 104 transmits image data to another one of the devices 10 via the network 30. Mail transmission, folder transmission, facsimile transmission, and the like correspond to the transmission by the transmission part 104. The transmission part 104 is implemented by the CPU 13, the RAM 15, the image memory 17, and the NIC 19 described above with reference to the hardware configuration diagram of FIG. 2.

A printing part 105 prints and outputs image data on recording media. The printing part 105 is implemented by the print engine 16 and the image memory 17 described above with reference to the hardware configuration diagram of FIG.

A communication part 106 performs data communications for device linkage and the like. The communication part 106 is implemented by the NIC 19 described above with reference to the hardware configuration diagram of FIG. 2.

Mobile Terminal

A linkage function controller 201 controls, in accordance with an instruction given from a user to perform linkage function, performing of the functions by the subject devices 10, and a sequence of operations of the devices 10 performing the functions. The linkage function controller 201 also controls the parts of the mobile terminal 20. The linkage function controller 201 is implemented by the CPU 22 and the RAM 24 described above with reference to the hardware configuration diagram of FIG. 3.

A communication part 202 performs data communications for device linkage and the like and data communications with a web server. The communication part 202 is implemented by the NIC 25 described above with reference to the hardware configuration diagram of FIG. 3.

A performing-function instruction part 203 instructs, under control of the linkage function. controller 201, the other devices 10 involved in linked operations to perform the functions. For example, the performing-function instruction part 203 instructs the printer 10P to perform printing using a print driver. The performing-function instruction part 203 is implemented by the CPU 22 and the RAM 24 described above with reference to the hardware configuration diagram of FIG. 3.

A device-information storage part 204 stores device linkage information containing network information (e.g., IP addresses) as device identification information about the devices 10 involved in linked operations and function information (i.e., information about functions to be performed by the subject devices 10). The device-information storage part 204 is implemented by the ROM 23, which includes the EEPROM or the like, described. above with reference to the hardware configuration diagram of FIG. 3.

A billing-information input part 205 accepts billing information representing function-use right (i.e., a right to use functions of the devices 10) when the billing information is entered thereto. Examples of the billing information entered to the billing-information input part 205 include the function-use right (amount of money), a serial number, as second billing information, corresponding to a function-use right (amount of money), and a function use permitted period corresponding to a function-use right. As a method for entering the billing information, the billing information may be manually entered by a user or automatically entered via the network 30. The billing-information input part 205 is implemented by the operating panel 21 and the NIC 25 described above with reference to the hardware configuration diagram of FIG. 3.

A billing-information storage part 206 stores, as billing-related information, the billing information entered to the billing-information input part 205 and information about billing amounts for respective available functions (i.e., information about unit costs for use of functions). The billing-information storage part 206 is implemented by the ROM 23, which includes the EEPROM or the like, described above with reference to the hardware configuration diagram of FIG. 3.

A performing-function-permission determination part 207 refers to the billing-related information stored in the billing-information storage part 206 and a function which is requested to be performed by a user via the linkage function controller 201, to determine whether or not the function is permitted to be performed. The performing-function-permission determination part 207 is implemented by the CPU 22 and the RAM 24 described above with reference to the hardware configuration diagram of FIG. 3.

A billing-information update part 208 updates the billing information (the function-use right (amount of money)) stored in the billing-information storage part 206 as a function-use balance. The billing-information update part 208 is implemented by the CPU 22 and the RAM 24 described above with reference to the hardware configuration diagram of FIG. 3.

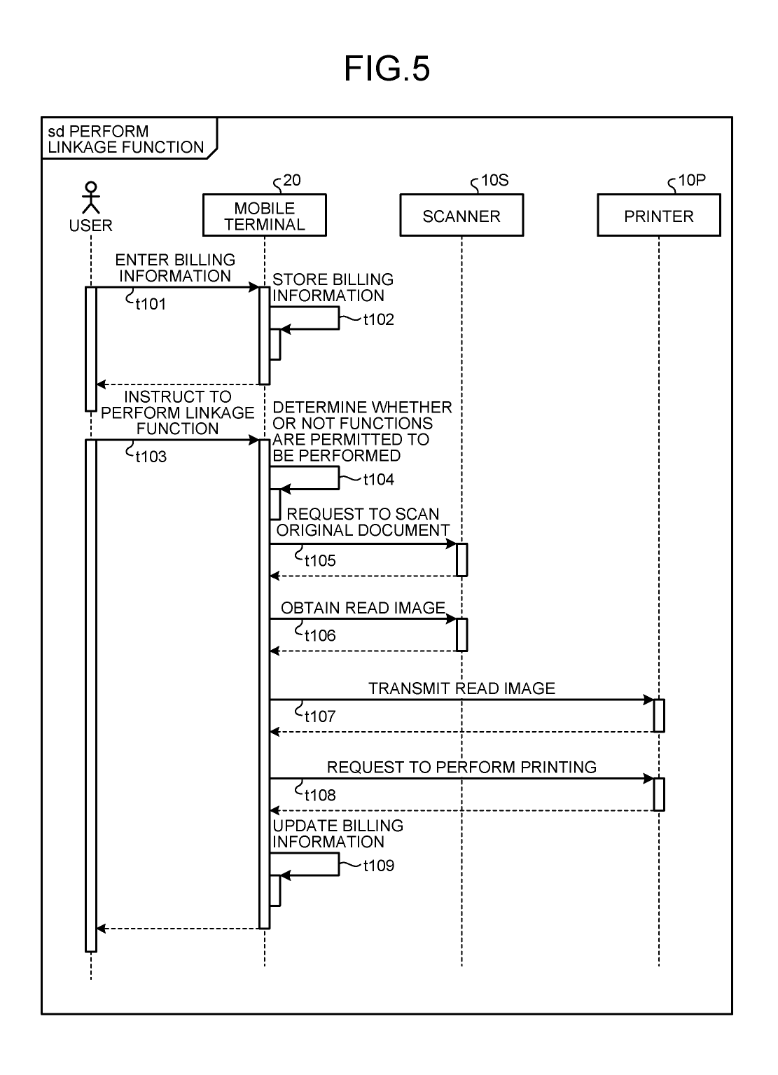

FIG. 5 is a sequence diagram illustrating a flow of processing between apparatuses when linking a scanning function of the discrete scanner 10S, which is one of the devices 10, and a printing function of the discrete printer 10P, which is another one of the devices 10, to perform a linkage function (in this example, “copying”) in the device linkage system of the present embodiment.

A user enters billing information to the mobile terminal 20 in advance (t101) to store the billing information in the mobile terminal 20 (t102). Specific examples of entering the billing information will be described later.

When an instruction, in which device identification information of two or more of the devices 10 to be linked and functions to be performed by the devices 10 are specified, to perform a linkage function is given to the mobile terminal 20 by the user (t103), the performing-function-permission determination part 207 of the mobile terminal 20 determines whether or not the functions to be performed by the devices 10 to be linked, are permitted to be performed. on the basis of the billing-related. information stored in the billing-information storage part 206 (t104).

If it is determined that the linkage function is permitted to be performed, under control of the linkage function controller 201, the performing-function instruction part 203 causes the corresponding devices 10 to perform the requested functions.

Referring to the example of FIG. 5, the mobile terminal 20 requests the scanner 105 to scan an original document (t105), obtains a read image from the scanner 10S (t106), transmits the read image to the printer 10P (t107), and requests the printer 10P to perform printing (t108).

The function linkage system of the present embodiment links the scanner 105 and the printer 10P in this manner, thereby implementing the linkage function (in this example, “copying”), which are scanning and printing an original document performed in series. If it is determined that the linkage function is not permitted to be performed, the linkage function controller 201 ends the series of processing.

Lastly, the billing-information update part 208 of the mobile terminal 20 updates the billing information (function-use balance) in accordance with the billing amounts for respective functions and the performed functions (t109). The details will be described later.

### (1) First Example of Entering Billing Information (Entering Billing Information Via a Web Server 40

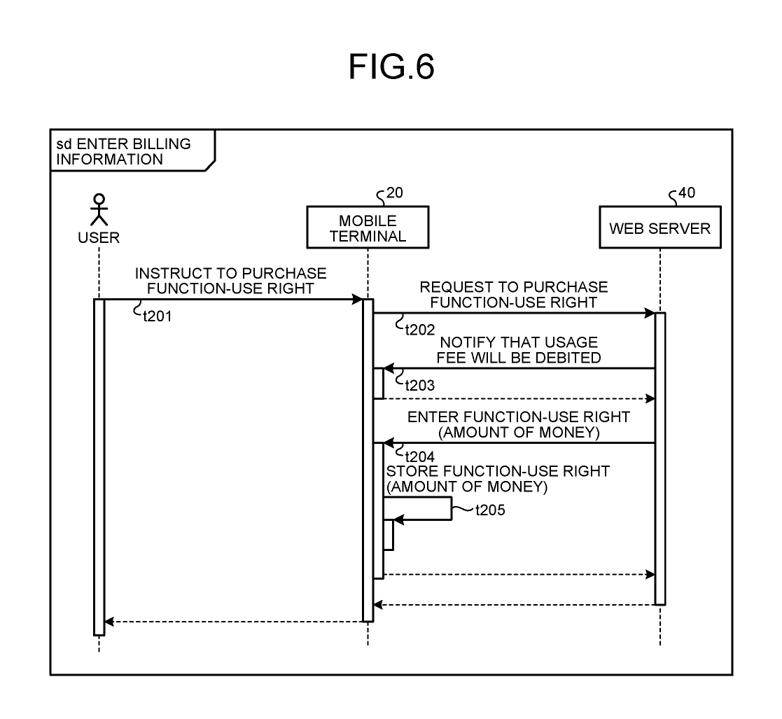

FIG. 6 is a sequence diagram illustrating a flow of processing between the mobile terminal 20 and the web server 40 when a user operates the mobile terminal 20 to purchase a function-use right (amount of money) from the web server 40 in the present embodiment. In the example illustrated in FIG. 6, the billing information is a balance of the function-use right (amount of money) purchased by the user or, in short, function-use balance.

When the user performs an operation for purchasing the function-use right to gives an instruction to purchase the function-use right to the mobile terminal 20 (t201), the billing-information input part 205 of the mobile terminal 20 requests the web server 40 of a system providing vendor for purchasing the function-use right (t202). The web server 40 notifies the mobile terminal 20 that a process for debiting a usage fee for the function-use rig (amount of money), purchase of which is requested, from the user's side will be performed (t203), and transmits and enters the function-use right (amount of money) to the mobile terminal 20 (t204).

The billing-information input part 205 of the mobile terminal 20 causes the function-use right (amount of money) entered from the web server 40 to be stored as the billing information in the billing-information storage part 206 (t205).

In the configuration described above, is necessary to build the web server 40. However, because the web server 40 in this configuration performs only processing with the mobile terminal 20 for selling, as the billing information, the function-use right (amount of money), the web server 40 is not required to manage the devices 10 and the functions to be used by users. Accordingly, the need for building a server for managing a linkage function at each of system managers is eliminated, and the cost for introducing such a server that would otherwise be placed on each of the system managers can be eliminated. Furthermore, processing between the mobile terminal 20 and the web server 40 for purchasing/selling a function-use right can be implemented without newly building a purchase system, by utilizing one of widespread application purchase systems provided by OS vendors to mobile terminals, such as smartphones.

### (2) Second Example of Entering Billing Information (Entering Billing Information Via the Web Server 40 After Purchasing a Function-Use Right at a Store 50

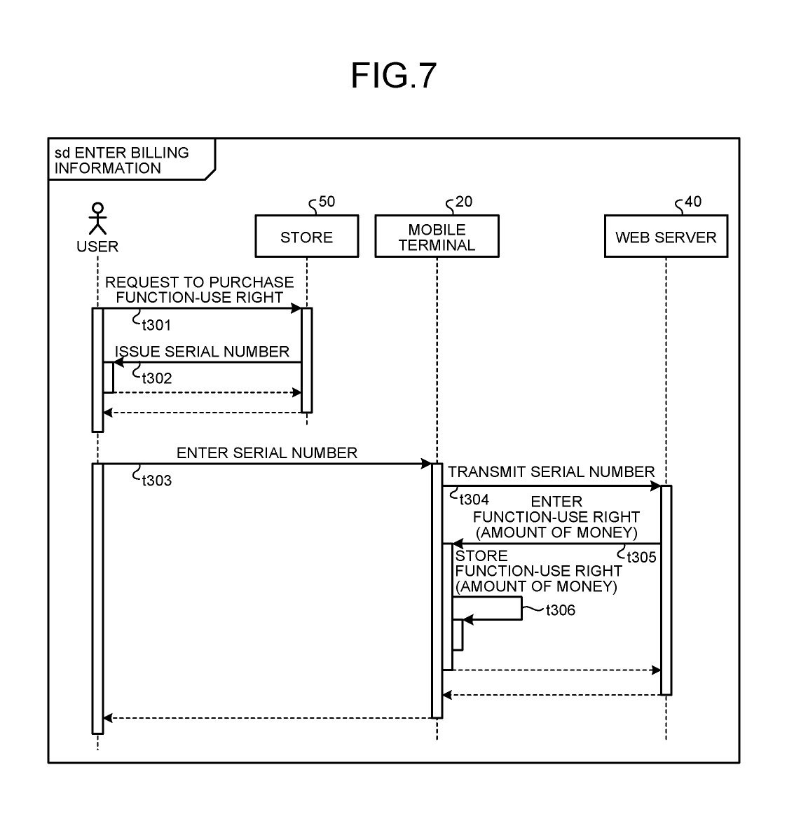

FIG. 7 is a sequence diagram illustrating a procedure and a flow of processing between a user, the mobile terminal 20, and the web server 40 when the user purchases a function-use right at the store 50 in the present embodiment.

When the function-use right is purchased by the user at the store 50 (t301), the corresponding serial number is issued (t302). When the obtained serial number is entered to the mobile terminal 20 by the user (t303), the billing-information input part 205 of the mobile terminal 20 transmits the serial number to the web server 40 (t304). Upon receiving the serial number from the mobile terminal 20, the web server 40 transmits and enters the function-use right (amount of money) corresponding to the serial number to the billing-information input part 205 of the mobile terminal 20 (t305).

The billing-information input part 205 of the mobile terminal 20 stores the function-use right (amount of money) entered from the web server 40 in the billing-information storage part 206 as the billing information (t306).

In this example, because the usage fee is paid at the store 50, the need for the web server 40 to perform processing, such as debiting the usage fee from the user's side, is eliminated.

In each of the first and second examples of entering billing information, the user can purchase a function-use right to match with desired functions. Furthermore, the user can select functions that the user is to use, depending on the function-use balance after purchase of the function-use right.

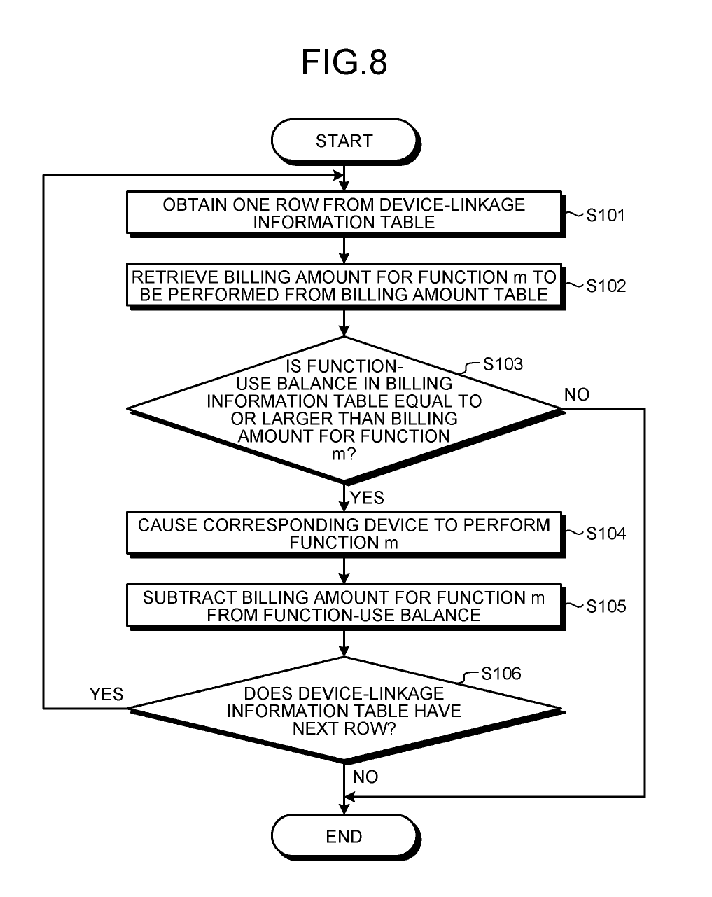

FIG. 8 is a flowchart describing how the mobile terminal 20 operates in the present embodiment when causing a linkage function to be performed.

A user purchases a function-use right in advance as described above and stores a function-use balance, as billing information, in a billing information table, an example of which is given in Table 1 below.

TABLE 1
Billing Information Table

| Row number | Function-use balance |
|---|---|
| 1 | 1,000 yen |

The system manager stores available functions and billing amounts for use of the functions in a billing amount table, an example of which is given in Table 2 below, in advance.

TABLE 2
Billing Amount Table

| Row number | Function | Billing amount |
|---|---|---|
| 1 | scan original document | 0 yen |
| 2 | black-and-white printing | 10 yen |
| 3 | full-color printing | 50 yen |

Further, according to an instruction to perform a linkage function from a user, device, information about the devices 10 to be linked are stored in an order of performing the functions, and thereby a device-linkage information table, an example of which is given in Table 3, is created. The device information contains IP addresses of the devices 10, as device identification information of the devices 10, and information about the functions to be performed by the devices 10.

TABLE 3
Device-Linkage Information Table

| Row number | IP address of device | Function to be performed |
|---|---|---|
| 1 | AA.AA.AA.AA | scan original document |
| 2 | BB.BB.BB.BB | black-and-white printing |

The device information is specified by the user when the instruction. to perform the linkage function is given. Although the IP addresses of the devices 10 are used as the device identification information in this example, the device identification information. can be any addresses usable in a network to be used and may vary depending on a structure of the network to be used.

In the present embodiment, the linkage function controller 201 reads out the device information stored in the device-linkage information table one row by one row in accordance with the instruction to perform the linkage function entered by the user and causes the devices 10 to perform the functions. How processing is performed is specifically described below.

The linkage function controller 201 of the mobile terminal 20 obtains one row from the device-linkage information table (S101). This one row contains an IP address of the device 10 and a function m (one of the functions to be linked) to be performed.

Thereafter, the performing-function-permission determination part 207 retrieves a billing amount for the function m to be performed from the billing amount table (S102).

Thereafter, the performing-function-permission determination part 207 obtains the function-use balance from the billing information table and determines whether the function-use balance is equal to or larger than the billing amount for the function m to be performed (S103).

If the function-use balance is equal to or larger than the billing amount (Yes at S103), the linkage function controller 201 causes the corresponding device 10 to perform the function in via the performing-function instruction part 203 (3104). The billing-information update part 208 subtracts the billing amount from the function-use balance in the billing information table (S105) to update the function-use balance, which is the billing information.

Thereafter, the linkage function controller 201 determines whether the device-linkage information table has a next row (S106). If the device-linkage information table has a next row (Yes at S106), control returns to S101; otherwise (No at S106), the series of processing ends.

On the other hand, if it is determined at S103 that the function-use balance is smaller than the billing amount (No at S103), the series of processing ends without performing the function m.

In the present embodiment, when settings are as illustrated in Table 1 to Table 3, because black-and-white printing, billing amount for which is 10 yen, of the row number 2 in the device-linkage information table is performed with the usage balance of 1,000 yen, the usage balance becomes 990 yen after black-and-white printing is performed. Thereafter, the series of processing ends.

### Second Embodiment

A device linkage system of a second embodiment is described below. Hardware configurations and functional configurations of the devices 10 and the mobile terminal 20 are similar to the hardware configurations and functional configurations in the first embodiment described above. Information (items) to be stored in Lie billing information table, the billing amount table, and the device-linkage information table is also similar to the information described above in the first embodiment.

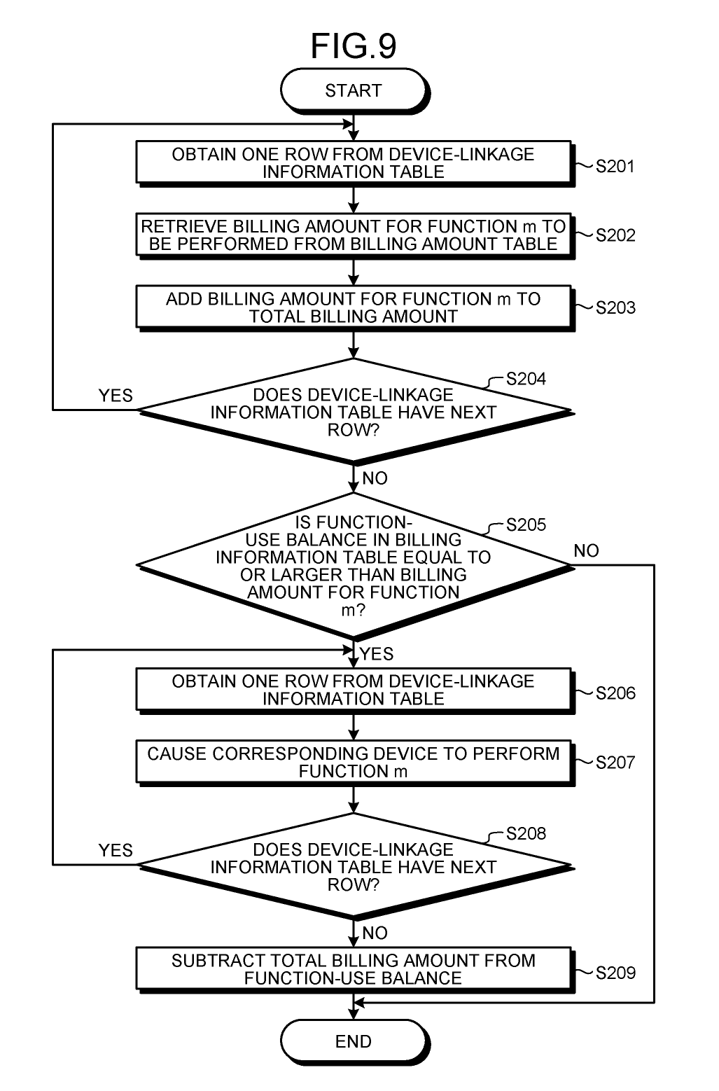

How the mobile terminal 20 operates in the present embodiment when causing a linkage function to be performed is described below. FIG. 9 is a flowchart describing how the mobile terminal 20 operates in the present embodiment when causing a linkage function to be performed.

The linkage function controller 201 of the mobile terminal 20 obtains one row from the device-linkage information table (S201). This one row contains an IP address of the device 10 and the function m to be performed.

Thereafter, the performing-function-permission determination part 207 retrieves a billing amount for the function m to be performed from the billing amount table (S202).

Thereafter, the performing-function-permission determination part 207 adds the billing amount for the function m to a total billing amount (S203). An initial value of the total billing amount is zero.

Thereafter, the linkage function controller 201 determines whether the device-linkage information table has a next row (S204). If the device-linkage information table has a next row (Yes at S204), control returns to S201; otherwise (No at S204), control proceeds to 3205.

At S205, the performing-function-permission determination part 207 determines whether the function-use balance is equal to or larger than the total billing amount for the function in to be performed (S205).

If the function-use balance is equal to or larger than the total billing amount (Yes at S205), control proceeds to S206; otherwise (No at S205), the series of processing ends.

At S206, the linkage function controller 201 obtains one row from the device-linkage information table (S206).

Thereafter, the performing-function instruction part 203 causes the corresponding device 10 to perform the function m (3207).

Thereafter, the linkage function controller 201 determines whether the device-linkage information table has a next row (S208). If the device-linkage information table has a next row (Yes at S208), control returns to S206; otherwise (No at S208), the billing-information update part 208 subtracts the total billing amount from the function-use balance in the billing information table (S209) to update the function-use balance, which is the billing information. Then, the series of processing ends.

As described above, in the present embodiment, in the mobile terminal 20, before causing a linkage function to be performed, the linkage function controller 201 acquires information about the functions to be performed from the device-linkage information table. The performing-function-permission determination part 207 calculates a total billing amount necessary for performing the series of functions for the linkage function. Thereafter, in the mobile terminal 20, if the function-use balance is equal to or larger than the total billing amount, after the linkage function controller 201 performs control to cause the series of functions for the linkage function to be performed, the billing-information update part 208 subtracts the total billing amount from the function-use balance. However, if the function-use balance is smaller than the total billing amount, the series of processing ends without performing the linkage function at all.

Assume that Table 4, Table 5, and Table 6 presented below are given as the billing information table, the billing amount table, and the device-linkage information table, respectively, for example.

TABLE 4
Billing Information Table

| Row number | Function-use balance |
|---|---|
| 1 | 20 yen |

TABLE 5
Billing Amount Table

| Row number | Function | Billing amount |
|---|---|---|
| 1 | scan original document | 0 yen |
| 2 | perform OCR on image | 10 yen |
| 3 | transmit mail with image | 20 yen |
| | attached | |

TABLE 6
Device-Linkage Information Table

| | IP address of | |
|---|---|---|
| Row number | device | Function to be performed |
| 1 | AA.AA.AA.AA | scan original document |
| 2 | BB.BB.BB.BB | perform OCR on image |
| 3 | CC.CC.CC.CC | transmit mail with image |
| | | attached |

With the settings given in these tables, “perform OCR on image”, billing amount for which is 10 yen, of the row number 2 in the device-linkage information table and “transmit mail with image attached”, billing amount for which is 20 yen, of the row number 3 are performed. with the function-use balance of 20 yen. Therefore, a total billing amount, which is 30 yen, is smaller than the function-use balance. Accordingly, processing ends without performing the linkage function. Thus, the present embodiment can prevent an undesirable situation that, for example, for a user that desires to obtain a result of a series of functions for the linkage function of performing OCR on image data and transmitting the image data by a mail, only the OCR process is performed and the processing ends due to insufficient balance.

### Third Embodiment

A device linkage system of a third embodiment is described below. Hardware configurations of the devices 10 and the mobile terminal 20 are the same as in the first embodiment described above. Information (items) to be stored in the billing information table, the billing amount table, and the device-linkage information table is also similar to the information described above in the first embodiment.

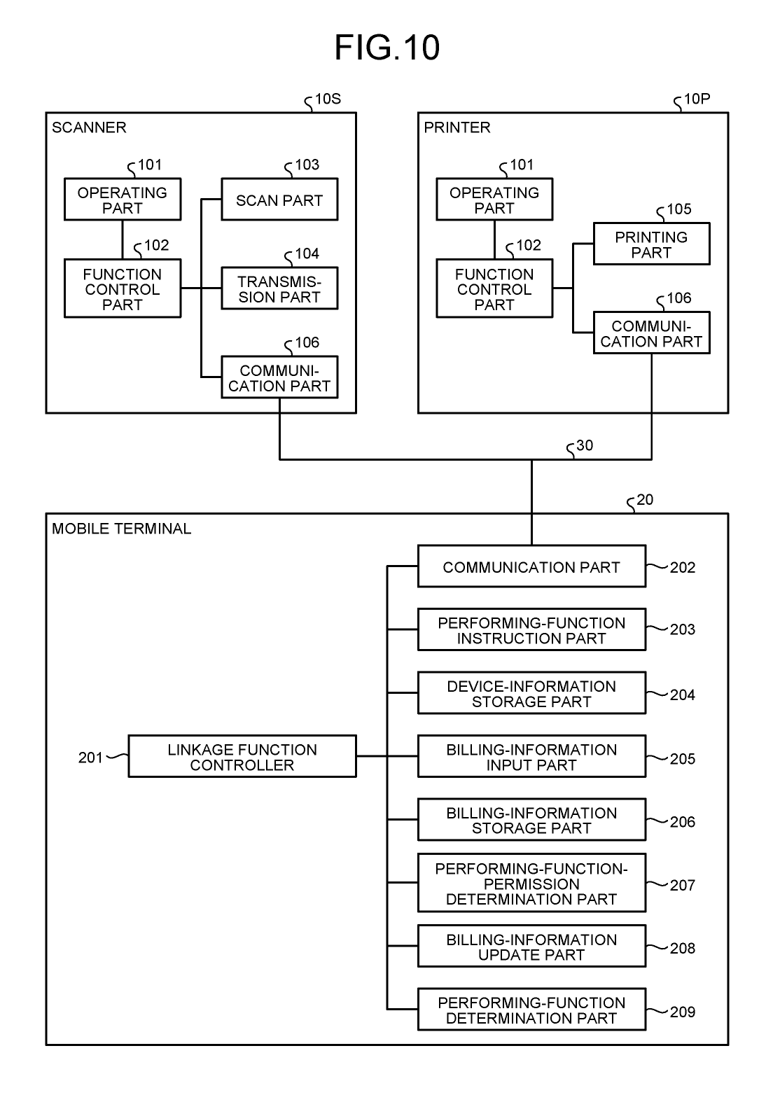

FIG. 10 is a block diagram illustrating an example of a functional configuration of the device linkage system of the present embodiment implemented with the discrete scanner 103 and the discrete printer 10P, which are the devices 10, and the mobile terminal 20. As illustrated in FIG. 10, the functional configuration of the mobile terminal 20 of the present embodiment differs from the first embodiment illustrated in FIG. 4 only in additionally including a performing-function determination part 209. The performing-function determination part 209 is a functional part that determines whether or not a “function to be performed” has been successfully performed and implemented by the CPU 22 and the RAM 24 described above with reference to the hardware configuration diagram of FIG. 3.

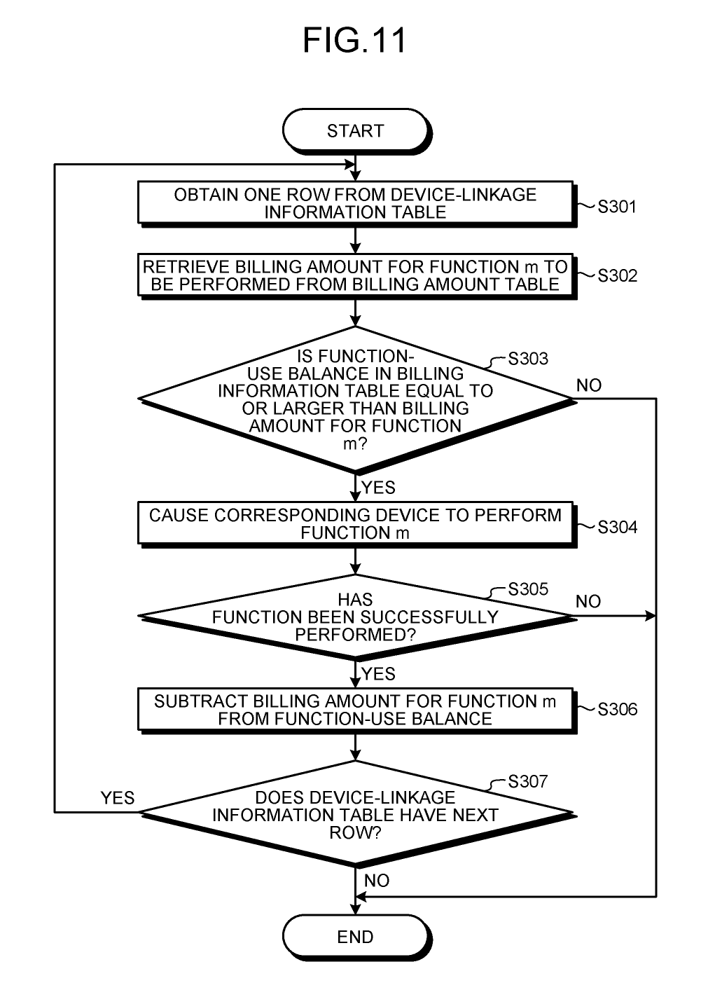

FIG. 11 is a flowchart describing how the mobile terminal 20 operates in the present embodiment when causing a linkage function to be performed.

As is apparent from comparison with the flowchart of the first embodiment illustrated in FIG. 8, S301 to S304, S306, and S307 correspond to S101 to S104, S105, and S106 of the first embodiment described above, respectively; the present embodiment is similar to the first embodiment described above in principle and overall procedure. However, the present embodiment differs from the first embodiment in that determination about a result of performing a function is made at S305 between processing at S301 to S304 related to linkage function execution and processing at S306 and S307 related to updating billing information. At S305, the performing-function determination part 209 determines whether or not the “function to be performed” has been successfully performed.

In the present embodiment, if it is determined that the “function to be performed” has been successfully performed at S305 (Yes at S305), the billing amount is subtracted from the function-use balance (S306). However, if it is determined that the “function to be performed” has not been successfully performed (i.e., the result of performing the function is a failure) (No at S305), the series of processing ends without subtraction from the function-use balance.

Assume that Table 7, Table 8, and Table 9 presented below are given as the billing information table, the billing amount table, and the device-linkage information table, respectively, for example.

TABLE 7
Billing Information Table

| Row number | Function-use balance |
|---|---|
| 1 | 1,000 yen |

TABLE 8
Billing Amount Table

| Row number | Function | Billing amount |
|---|---|---|
| 1 | scan original document | 0 yen |
| 2 | black-and white printing | 10 yen |
| 3 | full-color printing | 50 yen |

TABLE 9
Device-Linkage Information Table

| | IP address of | |
|---|---|---|
| Row number | device | Function to be performed |
| 1 | AA.AA.AA.AA | scan original document |
| 2 | BB.BB.BB.BB | black-and-white printing |

In this example, when black-and.-white printing of the row number 2 in the device-linkage information table is successfully performed, the function-use balance becomes 990 yen; however, if performing the black-and-white printing results in a failure, processing ends with the function-use balance unchanged from 1,000 yen. Thus, an undesirable situation that a usage fee is subtracted in spite that a desired function cannot be provided to a user can be prevented.

### Fourth Embodiment

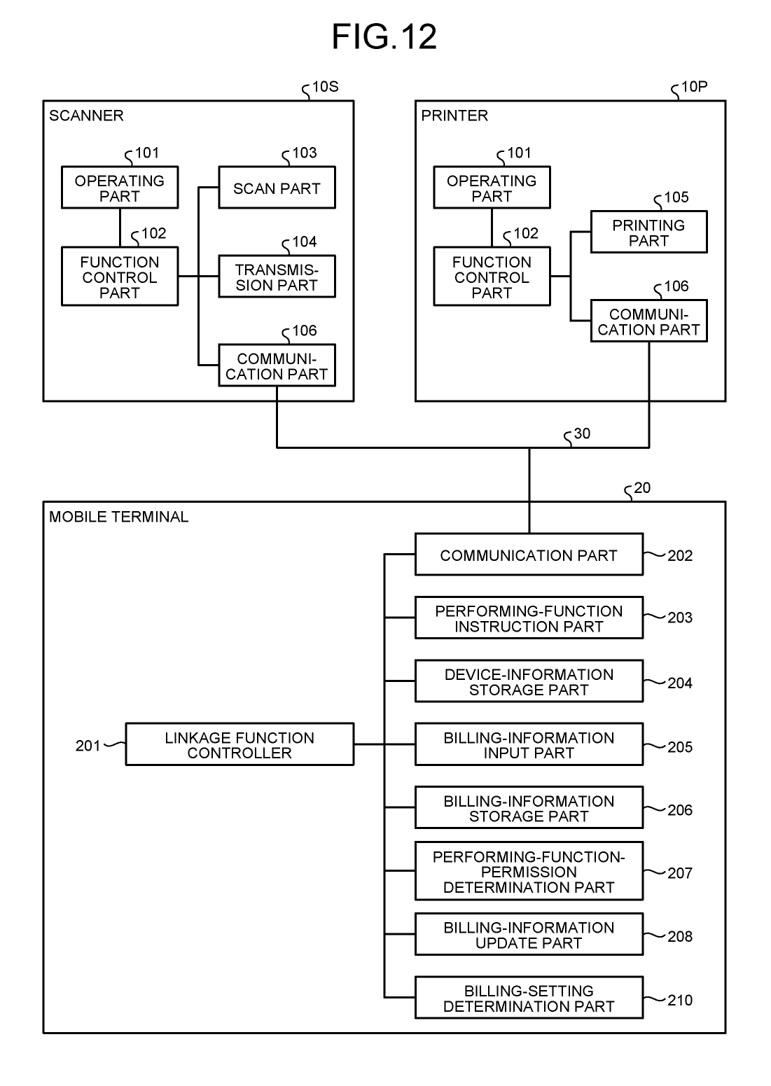

A device linkage system of a fourth embodiment is described below. Hardware configurations of the devices 10 and the mobile terminal 20 are the same as in the first embodiment described above. Information (items) to be stored in the billing information table and the billing amount table is also similar to the information described above in the first embodiment. However, in the present embodiment, the device-linkage information table has a setting item “external billing”, to which “enabled” or “disabled” is set. In accordance with an instruction to perform a linkage function given from a user, the linkage function controller 201 stores whether external billing is enabled or dlsabled in the device-linkage information table in addition to device information about the devices 10 to be linked (IP addresses of the corresponding devices 10 as device identification information of the corresponding devices 10, and the functions to be performed by the corresponding devices 10). FIG. 12 illustrates a functional configuration of the mobile terminal 20.

FIG. 12 is a block diagram illustrating an example of a functional configuration of the device linkage system of the present embodiment implemented with the discrete scanner is and the discrete printer 10P, which are the devices 10, and the mobile terminal 20.

As illustrated in FIG. 12, the functional configuration of the mobile terminal 20 of the present embodiment differs from the example functional configuration of the first embodiment illustrated in FIG. 4 only in additionally including a billing-setting determination part 210. The billing-setting determination part 210 is a functional part that determines whether billing on an individual device basis is enabled or disabled or, in other words, whether or not billing is charged externally, and that is implemented by the CPU 22 and the RAM 24 described above with reference to the hardware configuration diagram of FIG. 3.

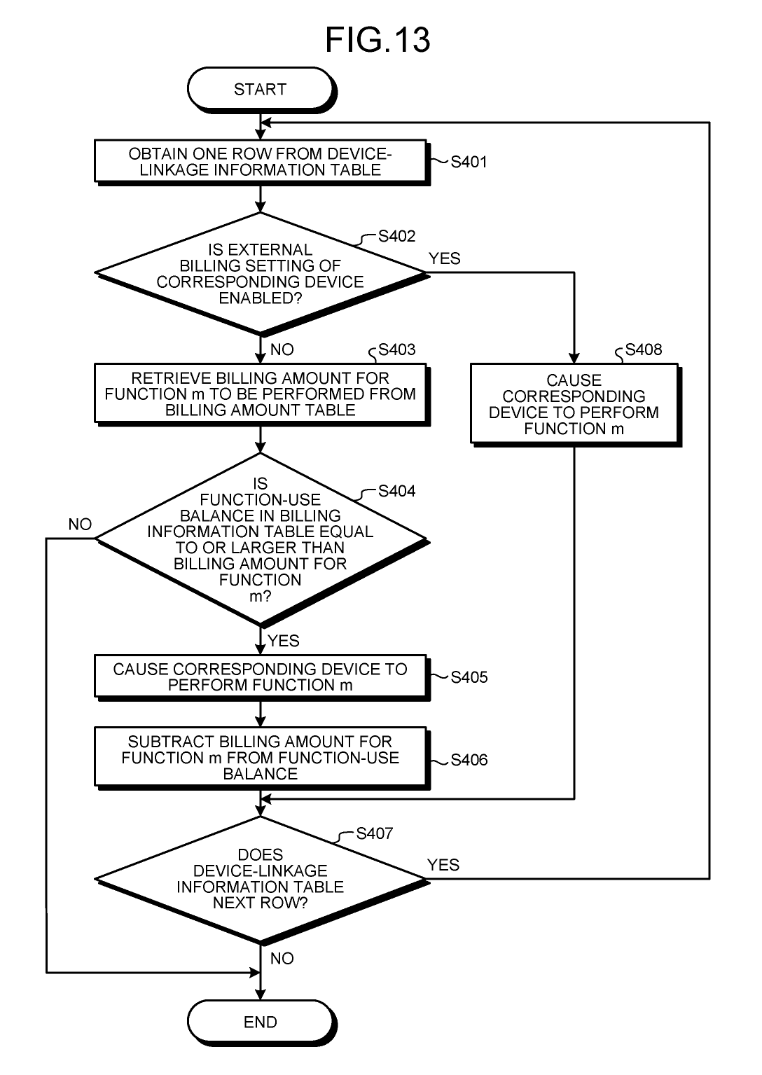

FIG. 13 is a flowchart describing how the mobile terminal 20 operates in the present embodiment when causing a linkage function to be performed.

As is apparent from comparison with the flowchart of the first embodiment illustrated in FIG. 8, S401, and S403 to S407 correspond to S101, and S102 to S106 of the first embodiment described above, respectively; the present embodiment is similar to the first embodiment described above in principle and overall procedure. However, the present embodiment differs from the first embodiment in that determination about external billing setting is made at 3402 between processing at S401 for acquiring device information and processing at S403 to S407 related to linkage function execution and updating billing information. The present embodiment differs from the first embodiment in that, if it is determined that external billing setting is “enabled” (Yes at S402), the corresponding device 10 is made to perform the specified function in with billing-related processing at S408 skipped, and thereafter control proceeds to S407. At S402, the billing-setting determination part 210 determines whether the external billing setting is “enabled” or “disabled”. At S408, the linkage function controller 201 causes the corresponding device 10 to perform the specified function m via the performing-function instruction part 203.

Thus, in the present embodiment, when one row is obtained by the linkage function controller 201 from the device-linkage information table (S401), the billing-setting determination part 210 determines whether billing on an individual device basis is enabled or disabled on the basis of external billing setting of the device 10 contained in the information obtained from the device-linkage information table (S402). If it is determined that the billing is disabled (No at S402), processing is performed as in the first embodiment described above; if it is determined that billing is enabled, simply the corresponding function is performed (S408). Put another way, if the external billing setting is “enabled”, the billing-information update part 208 does not update the billing information after the linkage function controller 201 have caused the corresponding device 10 to perform the corresponding function.

Assume that Table 10, Table 11, and Table 12 presented below are given as the billing information table, the billing amount table, and the device-linkage information table, respectively, for example.

TABLE 10
Billing Information Table

| Row number | Function-use balance |
|---|---|
| 1 | 1,000 yen |

TABLE 11
Billing Amount Table

| Row number | Function | Billing amount |
|---|---|---|
| 1 | scan original document | 0 yen |
| 2 | black-and-white printing | 10 yen |
| 3 | full-color printing | 50 yen |

TABLE 12
Device-Linkage Information Table

| Row | IP address of | Function to be | External |
|---|---|---|---|
| number | device | performed | charging |
| 1 | AA.AA.AA.AA | scan original | disabled |
| | | document | |
| 2 | BB.BB.BB.BB | black-and-white | enabled |
| | | printing | |

In this example, black-and-white printing of the row number 2 in the device-linkage information table is performed. However, because external billing setting for the printer 10P, which is the corresponding device 10, is “enabled”, subtraction from the function-use balance in the billing information table is not performed and the function-use balance is unchanged from 1,000 yen even after black-and-white printing is completed. Note that the device 10 whose external billing setting is “enabled”, is charged based on a usage count counted with a counter, for example. Thus, the present embodiment can prevent occurrence of double charging such as that in spite that billing is charged externally on an individual device basis, subtraction from the function-use balance is also done.

### Fifth Embodiment

A device linkage system of a fifth embodiment is described below. Hardware configurations and functional configurations of the devices 10 and the mobile terminal 20 are the same as in the first embodiment described above. Information (items) to be stored in the billing information table, the billing amount table, and the device-linkage information table is also similar to the information described above in the first embodiment. In the first to fourth embodiments, it is assumed that the system for purchasing a function-use right, utilizes the web server 40 of an existing purchase system. In the present embodiment, the web server 40 is configured to further include a serial-number-validity determination part described later as a second billing-information determination part, and a serial-number invalidation part as a second-billing-information invalidation part.

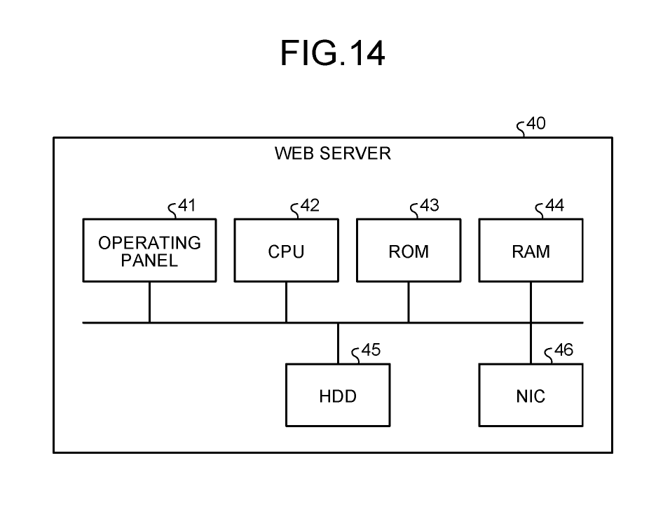

FIG. 14 is a block diagram illustrating an example of a hardware configuration of the web server 40 of the present embodiment. As illustrated in FIG. 14, the web server 40 of the present embodiment has a hardware configuration similar to the hardware configuration of a general web server and includes an operating panel 41, a CPU 42, a ROM 43, a RAM 44, an HDD 45, and an NIC 46. Note that the hardware configuration of the web server 40 presented in FIG. 14 is merely illustrative and not limiting.

The operating panel 41 is an apparatus including a GUI for use by a user in performing operations and includes an LCD (Liquid Crystal Display) and an input device, such as a hard key and a touch panel. The operating panel 41 displays a variety of information on the LCD and accepts a variety of information from the hard key and the touch panel.

The CPU 42 is a processor that performs processing and overall control of the web server 40. The ROM 43 stores a program to be executed by the CPU 42, a variety of setting information, and the like. The RAM 44 is a main storage of the CPU 42 and also used as a work area of the CPU 42. The CPU 42 loads the program stored in the ROM 43 into the RAM 44 and executes the program to perform processing and overall control of the web server 40. The HDD 45 stores setting data and a variety of data for use by the CPU 42.

The NIC 46 is a communication interface for connecting the web server 40 to the Internet.

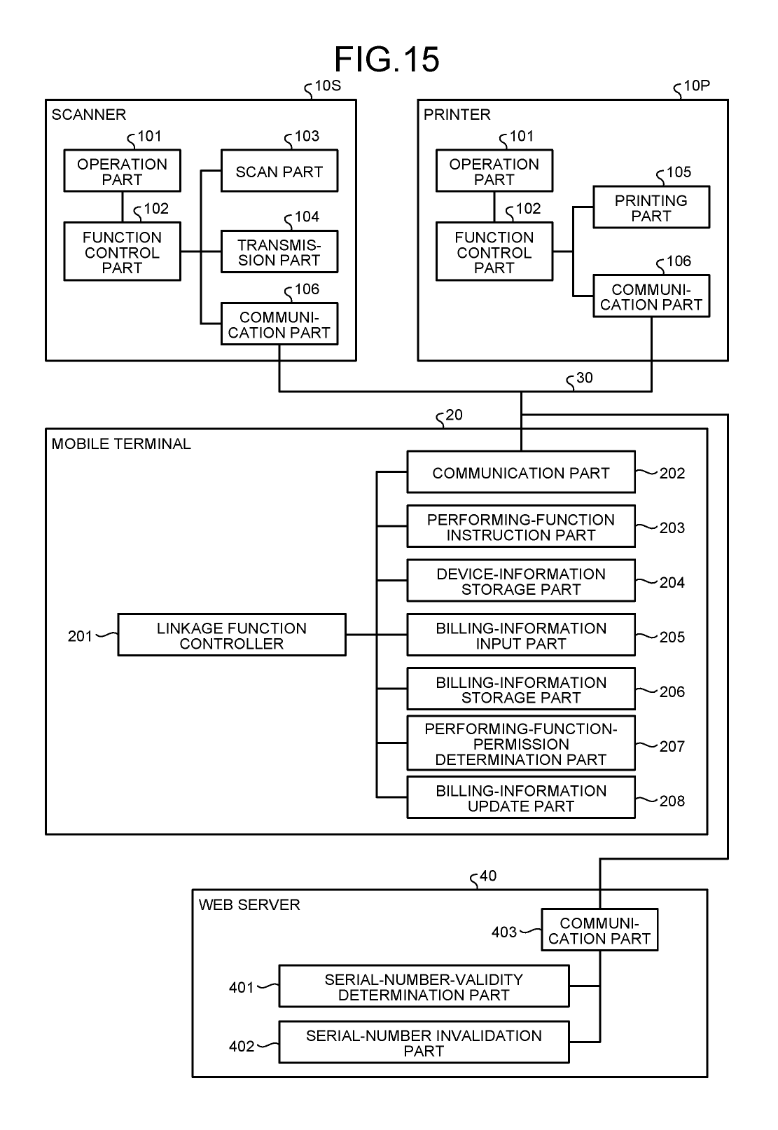

FIG. 15 is a block diagram illustrating an example of a functional configuration of a device linkage system of the present embodiment implemented with the discrete scanner 10S and the discrete printer 10P, which are the devices 10, the mobile terminal 20, and the web server 40. The functional configurations of the discrete scanner 10S, the discrete printer 10P, and the mobile terminal 20 are similar to the functional configurations in the first embodiment and description of the functional configurations is omitted.

The web server 40 of the present embodiment can be implemented by adding a serial-number-validity determination part 401 and a serial-number invalidation part 402 illustrated in FIG. 15 to a web server of an existing purchase system. The serial-number-validity determination part 401 determines validity of a serial number received from the mobile terminal 20. The serial-number invalidation part 402 invalidates, after a function-use right, has been sold, the corresponding serial number. The serial-number-validity determination part 401 and the serial-number invalidation part 402 are implemented by the CPU 42, the RAM 44, and the HDD 45 described above with reference to the hardware configuration diagram of FIG. 14. A communication part 403 is a communication interface for connecting the web server 40 to the network 30 and implemented by a communication interface provided in the web server of the existing purchase system.

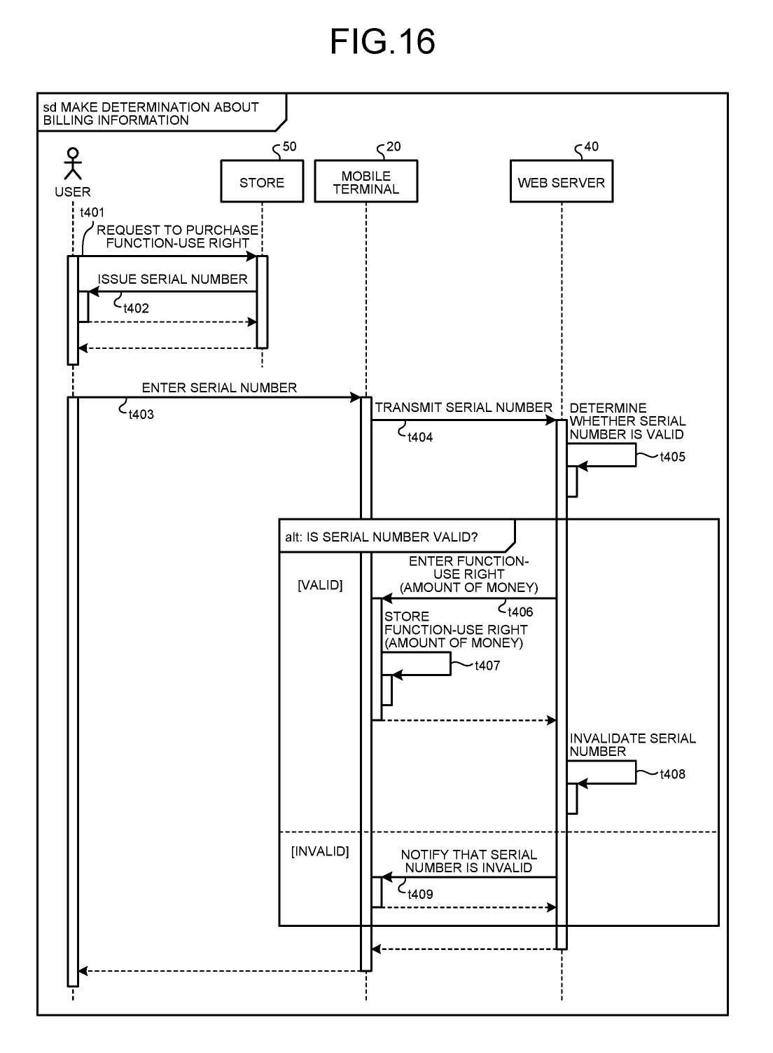

FIG. 16 is a sequence diagram illustrating a procedure and a flow of processing (for making determination about billing information) between a user, the mobile terminal 20, and the web server 40 when the user purchases a function-use right at the store 50 in the present embodiment.

The present embodiment assumes that billing information is entered by the method described above with reference to FIG. 7 in the first embodiment, and t401 to t404, t406, and t407 of FIG. 16 correspond to t301 to t304, t305, and t306 of FIG. 7, respectively. In the present embodiment, the serial-number-validity determination part 401 of the web server 40 determines whether or not the serial number transmitted at t404 is valid. If the serial number is valid, the web server 40 enters the function-use right (amount of money) to the mobile terminal 20 (t406). Thereafter, the serial-number invalidation part 402 invalidates the corresponding serial number at t408. On the other hand, if the serial number is invalid, the serial-number-validity determination part 401 notifies the mobile terminal 20 that the serial number is invalid (t409).

As described above, in the web server 40 of the present embodiment, upon receiving a serial number, the serial-number-validity determination part 401 determines whether or not the serial number is valid and enters a function-use right (amount of money) to the mobile terminal 20 only when the serial number is valid. At this time, the serial number is invalidated by the serial-number invalidation part 402. Hence, even if an attempt of entering a used serial number a plurality of times or an attempt of entering the same serial number to the other mobile terminal 20 is made, the function-use right (amount of money) will not be increased because the serial number is invalidated. Accordingly, an attempt of a fraudulently increasing the function-use right (amount of money) can be prevented.

### Sixth Embodiment

A device linkage system of a sixth embodiment is described below. Hardware configurations of the devices 10 and the mobile terminal 20 are the same as in the first embodiment described above. Information (items) to be stored in the billing information table, the billing amount table, and the device-linkage information table is also similar to the information described above in the first embodiment.

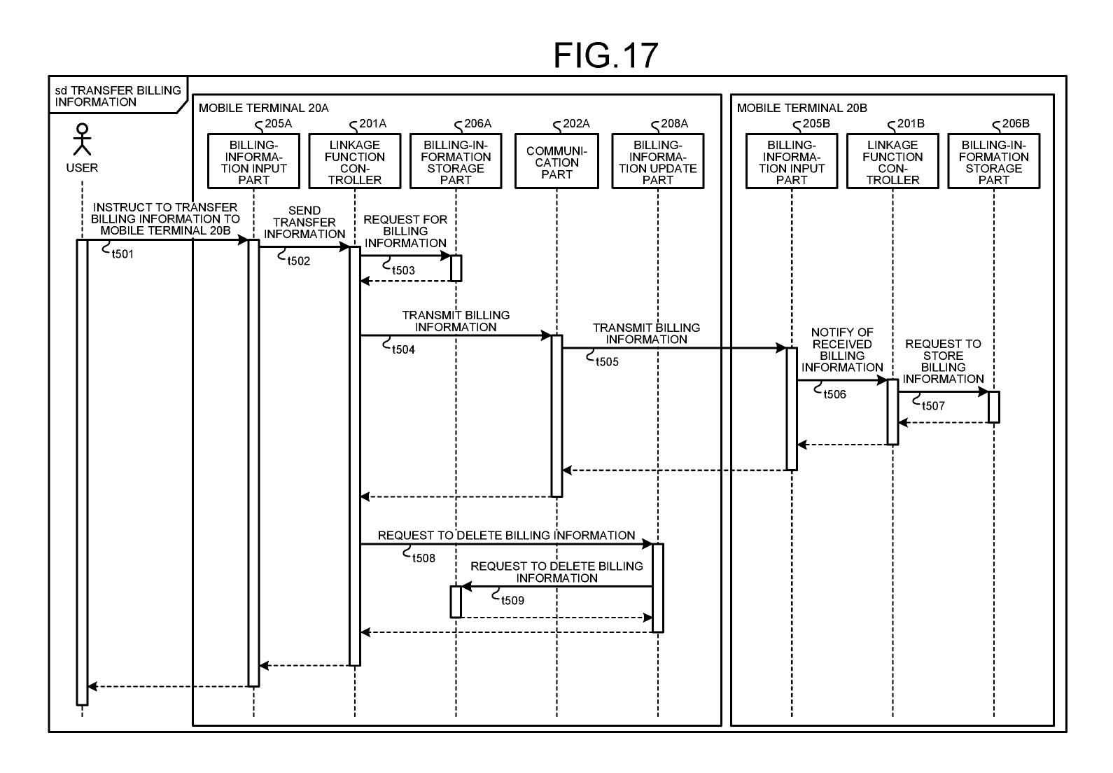

FIG. 17 is a sequence diagram illustrating a flow of processing when billing information is transferred to the other mobile terminal 20. FIG. 17 illustrates an example where a function-use right (amount of money) as billing information is transferred from a mobile terminal 20A to a mobile terminal 20B. In the description below, for differentiation between elements included in the mobile terminal 20A and elements in the mobile terminal 20B, “A” or “B” is added to each reference symbol.

When an instruction to perform transfer to the mobile terminal 20B, which is a transfer destination specified by a user, is given by the user to the mobile terminal 20A, which is a transfer source specified by the user, (t501), the billing-information input part 205A. sends transfer information (the transfer instruction and information about the transfer destination (e.g., an IP address)) to the linkage function controller 201A. (t502).

The linkage function controller 201A sends a request for billing information to the billing-information storage part 206A (t503) and acquires billing information. (function-use right (amount of money)) stored in the billing-information storage part 206A.

Thereafter, the linkage function controller 201A. transmits the billing information to the mobile terminal 20B via the communication part 202A (t504, t505).

Upon receiving the billing information (the function-use right (amount of money)) from the mobile terminal 20A, the billing-information input part 205B of the mobile terminal 20B notifies the linkage function controller 201B of the received billing information (the function-use right (amount of money)) (t506).

Upon being notified at t506, the linkage function controller 2013. requests the hilling-information storage part 206B to store the billing information (t507), thereby causing the transferred billing information (the function-use right (amount of money)) to be stored in the billing-information storage part 206B.

Thereafter, upon receiving a response from the mobile terminal 20B, the linkage function controller 201A. of the mobile terminal 20A requests the billing-information update part 208A to delete the billing information (t508).

In response to this request, the billing-information update part 208A requests the billing-information storage part 206A to delete the billing information (t509), thereby causing the billing information (the function-use right. (amount of money)) to be deleted from the billing-information storage part 206A.

As described above, when an instruction to perform transfer to the mobile terminal 2033, which is the transfer destination specified by the user, is given by the user to the mobile terminal 20A, which is the transfer source, the mobile terminal 20A, which is the transfer source, transmits billing information (the function-use right (amount of money)) to the mobile terminal 20B, which is the transfer destination. The mobile terminal 2033, which is the transfer destination, stores the received billing information. The mobile terminal 20A, which is the transfer source, deletes the billing formation, which has been transmitted, from the mobile terminal 20A. Accordingly, even in a case where, for example, a user purchases the mobile terminal 20, which is a new one, for replacement with the mobile terminal 20, which is an old one, the user can transfer billing information to the new mobile terminal 20 and continues to use the billing information.

### Seventh Embodiment

A device linkage system of a seventh embodiment is described below. Hardware configurations and functional configurations of the devices 10 and the mobile terminal 20 are the same as in the first embodiment described above. In the present embodiment, a function-use permitted period. is set in the billing information table for each of the functions in lieu of the function-use right (amount of money). A user pays fee for a period of usage in advance, for example, to store the function-use permitted period in the billing information table. In addition to IP addresses of the devices 10 and functions to be performed, the date and time when the function is to be performed are set in the device-linkage information table. The billing amount table is not necessary in the present embodiment.

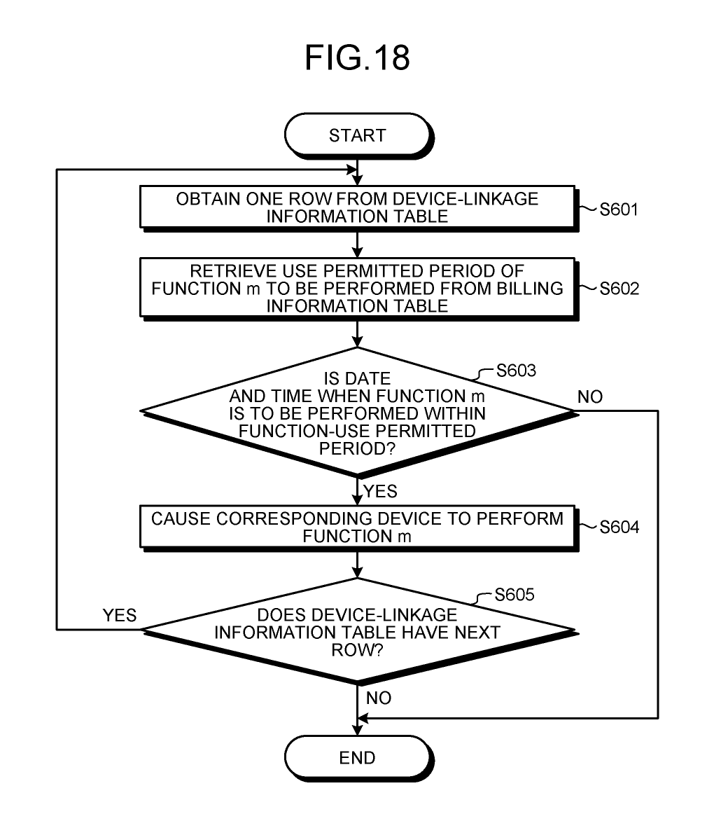

FIG. 18 is a flowchart describing how the mobile terminal 20 operates in the present embodiment when causing a linkage function to be performed.

As is apparent from comparison with the flowchart or the first embodiment illustrated in FIG. 8, S601, S604, and S605 correspond to S101, S104, and S106 of the first embodiment described above, respectively; the present embodiment is similar to the first embodiment described above in principle and overall procedure. However, the present embodiment differs from the first embodiment in that the performing-function-permission determination part 207 makes determination on the basis of a function to be used and a function-use permitted period of the function.

Specifically, after one row is obtained from the device-linkage information table by the linkage function controller 201 (S601), the performing-function-permission determination part 207 retrieves a use permitted period of the function m to be performed from the billing information. table (S602).

Thereafter, the performing-function-permission determination. part 207 determines whether the performing date and time contained in the information obtained at 3601 is within the function-use permitted period retrieved at S602 from the billing information table (S603).

If the performing date and time is within the function-use permitted period (Yes at S603), it is determined that the function m is permitted to be performed, and the linkage function controller 201 causes the corresponding device 10 to perform the function m via the performing-function instruction part 203 (S604). Otherwise (No at S603), it is determined that the function m is not permitted to be performed, and processing ends without performing the function m.

Assume that Table 13 and Table 14 presented below are given as the billing information table and the device-linkage information table, respectively, for example.

TABLE 13
Billing Information Table

| | | Function-use permitted |
|---|---|---|
| Row number | Function | period |
| 1 | scan original | Jan. 1, 2015 to Mar. 1, 2015 |
| | document | |
| 2 | black-and-white | Jan. 1, 2015 to Mar. 1, 2015 |
| | printing | |
| 3 | full-color printing | Jan. 1, 2015 to Feb. 1, 2015 |

TABLE 14
Device-Linkage Information Table

| | | | Performing |
|---|---|---|---|
| Row | IP address of | Function to be | date and |
| number | device | performed | time |
| 1 | AA.AA.AA.AA | scan original | Feb. 15, 2015 |
| | | document | |
| 2 | B.B.BB.BB.BB | black-and-white | Feb. 15, 2015 |
| | | printing | |
| 3 | CC.CC.CC.CC | full-color printing | Feb. 15, 2015 |

In the present embodiment, when the mobile terminal 20 causes each of the devices 10 to perform a function, whether the date and time when the function is to be performed is within the function-use permitted period is determined, and the function is performed only when the date and time is within the function-use permitted period. Accordingly, in the example presented in Table 13 and Table 14 above, only full-color printing, which is out of the function-use permitted period, is not performed. The present embodiment enables use of a billing style that permits using a function(s) as desired for a certain period, for which a usage fee is paid, for example. In the present embodiment, the billing-information update part 208 does not update the billing information stored in the billing-information storage part 206 after the function m is performed. Accordingly, with the present embodiment, the billing-information update part 208 can be omitted.

Various embodiments according to the present invention. have been described above. According to the embodiments described above, billing amounts for respective functions (unit costs) and function-use right (amount of money), as billing information is stored in advance in the mobile terminal 20 that controls a linkage function. The linkage function is performed by the devices 10 linked by the mobile terminal 20 only when it is determined that the functions are permitted to be performed on the basis of the stored information. Accordingly, the need for a billing management server or the like is eliminated. Furthermore, devices, such as inexpensive printers, can be used as the devices 10. Therefore, billing for use of a linkage function becomes possible while reducing the cost placed on a system manager for introducing a device linkage system and for operating the device linkage system.

All or a part of the linkage function controller 201, the communication part 202, the performing-function instruction part 203, the device-information storage part 204, the billing-information input part 205, the billing information storage part 206, the performing-function-permission determination part 207, the billing-information update part 208, the performing-function determination part 209, and the billing-setting determination part 210 included in the mobile terminal 20 described above can alternatively be included in an apparatus, e.g., a specific one of the devices 10 or a dedicated apparatus, other than the mobile terminal 20. The serial-number-validity determination part 401 and the serial-number invalidation part 402 included in the web server 40 can alternatively be included in any one of the apparatuses in the system capable of issuing a function-use right (amount of money) win response to a serial number being entered to the apparatus.

The program to be executed by the mobile terminal 20 of each of the embodiments may be configured to be embedded in the mobile terminal 20 (i.e., stored in the ROM 23) in advance. The program may be configured to be stored in a computer connected to a network, such as the Internet, and downloaded over the network to provide the program to the mobile terminal 20.

The program may be configured to be provided in the form of being recorded in a non-transitory computer-readable recording medium, such as a CD-ROM, a flexible disk (FD), a CD-R, and a DVD (Digital Versatile Disk) as an installable file or an executable file. In this case, the program is installed onto the mobile terminal 20 via a reader that reads the program from the recording medium where the program is recorded.

The program to be executed by the mobile terminal 20 of each of the embodiments have a modular configuration including the functional parts described above. From the viewpoint of actual hardware, the CPU (processor) 22 reads out the program from the recording medium, such as the ROM 23 and loads the program into the main storage medium (the RAM 24), thereby generating the function parts on the main storage medium.

According to an embodiment, billing for use of a linkage function becomes possible while reducing the cost placed on a system manager for introducing a device linkage system and for operating the device linkage system.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position and the shape are not limited the embodiments and thus may be preferably set. is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A device linkage system comprising:
a device-information storage part configured to store device linkage information containing device identification information of devices to be linked and information about functions to be performed by the devices;
a billing-information input part configured to accept billing information representing a function-use right;
a billing-information storage part configured to store billing-related information containing the billing information entered to the billing-information input part and information about unit costs for use of the functions;
a performing-function-permission determination part configured to determine whether or not the functions are permitted to be performed by the devices based on the billing-related information stored in the billing-information storage part;
a linkage function controller configured to perform control to cause at least one device of the devices to perform at least one function of the functions in accordance with the device linkage information stored in the device-information storage part if the performing-function-permission determination part determines that the at least one function is permitted to be performed by the at least one device; and
a billing-information update part configured to update the billing information stored in the billing-information storage part in accordance with the billing-related information stored in the billing-information storage part and the at least one function that the linkage function controller has caused the at least one device to perform.

2. The device linkage system according to claim 1, wherein the linkage function controller is configured to perform control to cause all the functions to be performed if the performing-function-permission determination part determines that all the functions to be performed specified in the device linkage information are permitted to be performed.

3. The device linkage system according to claim 1 further comprising
a performing-function determination part configured to make determinations about results of performing the functions to be performed, wherein
if the performing-function determination part determines that a result of performing at least one function of the functions is a failure, the billing-information update part does not update the billing information for the at least one function.

4. The device linkage system according to claim 1, further comprising
a billing-setting determination part configured to determine whether external billing setting of each of the devices to be linked is enabled or disabled, wherein
the billing-information update part is configured, with respect to at least one device whose external billing setting is determined to be enabled by the billing-setting determination part, of the devices, not to update the billing information concerning the at least one device after the linkage function controller performs control to cause the at least one device to perform at least one function of the functions.

5. The device linkage system according to claim 1, further comprising:
a billing-information determination part configured to determine whether entered second billing information is valid or invalid; and
a billing-information invalidation part configured to invalidate the second billing information, wherein
if the billing-information determination part determines that the second billing information is valid, the billing-information input part accepts the billing information representing a function-use right corresponding to the second billing information, and the second-billing-information invalidation part invalidates the second billing information.

6. The device linkage system according to claim 1, wherein
the linkage function controller performs control to transmit the billing information stored in the billing-information storage part to another apparatus in response to a predetermined instruction, and
the billing-information update part updates the billing information stored in the billing-information storage part in accordance with transmission of the billing information.

7. The device linkage system according to claim 1, wherein
at least one function-use permitted. period is stored in the billing-information storage part as the billing information, and
the performing-function-permission determination part determines that at least one function of the functions is permitted to be performed by at least one device of the devices if at least one date and time when the at least one function is co be performed by the at least one device is within the at least one function-use permitted period, but otherwise, determines that the at least one function is not permitted to be performed.

8. A method for controlling a device linkage system including a device-information storage part and a billing-information storage part and configured to link a plurality of devices connected over a network, the method comprising:
storing device linkage information containing device identification information of devices to be linked and information about functions to be performed by the devices;
causing billing information representing a function-use right, to be entered;
storing billing-related information containing the billing information entered at the causing and information about unit costs for use of the functions, in the billing-information storage part;
determining whether or not the functions are permitted to be performed by the devices based on the billing-related information stored in the billing-information storage part;
performing control to cause at least one device of the devices to perform at least one function of the functions in accordance with the device linkage information stored. in the device-information storage part if it is determined that the at least one function is permitted to be performed by the at least one device; and
updating the billing information stored in the billing-information storage part in accordance with the billing-related information stored in the billing-information. storage part and the at least one function made to be performed by the at least one device.

9 A. non-transitory recording medium including a computer program for controlling a device linkage system including a device-information storage part and a billing-information storage part and configured to link a plurality of devices connected over a network, the program causing a computer to perform:
storing device linkage information containing device identification information of devices to be linked and information about functions to be performed by the devices;
causing billing information representing a function-use right, to be entered;
storing billing-related information containing the billing information entered at the causing and information about unit costs for use of the functions in the billing-information storage part;
determining whether or not the functions are permitted to be performed by the devices based on the billing-related information stored in the billing-information storage part;
performing control to cause at least one device of the devices to perform at least one function of the functions in accordance with the device linkage information stored in the device-information storage part if it is determined that the at least one function is permitted to be performed by the at least one device; and
updating the billing information stored in the billing-information storage part in accordance with the billing-related information stored in the billing-information storage part and the at least one function made to be performed by the at least one device.
